(19) United States
(12) Patent Application Publication
(10) Pub. No.: US 2017/0011135 A1
(43) Pub. Date: Jan. 12, 2017

(54) Conversion Automation through Data and Object Importer

(71) Applicant: IGATE Global Solutions Ltd., Navi Mumbai (IN)

(72) Inventor: Navin Srivastava, Navi Mumbai (IN)

(21) Appl. No.: 14/920,948

(22) Filed: Oct. 23, 2015

(30) Foreign Application Priority Data
Jul. 6, 2015 (IN) 2582/MUM/2015

(51) Int. Cl. G06F 17/30; G06F 3/0484; G06F 17/24

(52) U.S. Cl. CPC G06F 17/30917; G06F 17/248; G06F 17/30929; G06F 3/0484

(57) ABSTRACT

A system, method, and computer program product are disclosed for automating the import of data from a legacy business software application into an enterprise resource planning (ERP) system. An import template includes a first plurality of XML tags, each tag in the first plurality of XML tags having SQL code implementing a mandatory or optional database process for importing the data. The import template is customized according to a selected business function, using a second plurality of XML tags, to perform pre-defined mandatory and selected optional database processes and to define a mapping of legacy application data fields to ERP system database fields. At a later time, the data are imported from the legacy application according to the customized import template. Import templates may be reused to perform multiple importations, and may be separately customized for each such importation.

### CROSS-REFERENCE TO RELATED APPLICATION

This application claims priority under 35 U.S.C. §119(a) to Indian application 2582/MUM/2015, filed Jul. 6, 2015 and naming the same inventor, the contents of which are incorporated by reference herein in their entirety.

### FIELD OF THE INVENTION

The invention generally relates to database and data structure creation and modification via a graphical user interface that is implemented using a combination of XML and SQL.

### BACKGROUND OF THE INVENTION

Enterprise resource planning, or ERP, software is business management software that a company can use to collect, store, manage and interpret data from many business activities. Such activities typically include product planning, manufacturing or service delivery, marketing and sales, inventory management, and shipping and payment. A complete ERP system typically includes a transactional database, a management portal or “dashboard”, a business intelligence subsystem, reporting functions, resource scheduling functions, product analysis tools, document management, instant messaging (“TM”) or chat functions, a knowledge base such as a wiki, and workflow management tools, among other features. ERP software is commercially available from a variety of software vendors, including Oracle Corporation of Redwood Shores, California, which sells its Oracle E-Business Suite (EBS).

ERP systems provide a large number of valuable business functions. However, each business is different, and employs different business functions. Therefore, each business must customize an ERP system to meet its own needs. To describe this process of matching built-in ERP functionality to existing business needs, Oracle uses the acronym “CEMLI”, which stands for Configuration, Extension, Modification, Localization, and Integration. In this context, “Configuration” means specifying various parameters in off-the-shelf functions of the ERP system to immediately implement a corresponding existing business function. “Extension” means creating in-house (or purchasing third-party) business- or industry-specific software that extends the ERP system to provide functionality not already present, typically using a variety of ERP application programming interfaces, or APIs, provided for this purpose. “Modification” means altering the off-the-shelf ERP software to tailor its functionality to business needs; this approach is a middle ground between configuration and extension. “Localization” means the process of conforming ERP tool features, such as text boxes, currency, time and date features, and so on, to one or more countries, regions, or languages. “Integration” means combining existing business software or data with a new ERP system, typically by migrating existing data into the ERP system and phasing out older software, where possible. Disclosed embodiments of the invention deal principally with the Integration process.

To describe requirements of an ERP system that may not be supported by the off-the-shelf functions, Oracle uses the acronym “RICE”, which stands for Reports, Interfaces, Conversions, and Enhancements. ERP software must be customized to provide the same reports (and/or input forms and workflows) already in legacy business software applications. Data interfaces must be established between legacy applications and the ERP system to permit migration (or at the very least, synchronization) of data between the systems. Conversion means transforming data structures, database table layouts, database procedure calls, and so on in existing business databases into a format suitable for importing into (or synchronizing with) the ERP system database. Enhancements (or extensions) include developing custom software within the context of the existing system without disturbing its core business functions. Disclosed embodiments of the invention deal principally with the Conversion process.

The process of converting data from existing business applications into an Oracle ERP system is often complex, and typically occurs in a three-step process. First, data are exported from the legacy application into a text file having delimited records. Each application may have a different process for exporting its data, and the process may be very laborious and time-consuming. Second, the records are loaded from the text file into an Oracle database. This process may be performed using a “data importer”, known in the art, that is configured to recognize the delimiting characters in fixed flat files, and perhaps to exclude certain portions of each record that are not relevant to the corresponding ERP application. Because the data model used in the legacy application likely is not the same as that used by the ERP application, this process may require extensive manipulation of the data. Third, the records in the database are attached to ERP applications using an “object importer”, as known in the art, that defines database objects (in the object-oriented programming sense) and connects them with the imported data and other such database objects. Each ERP application is defined according to an object model; the ERP application becomes functional once all objects in the model have been associated with underlying data structures according to this process.

Because these processes can be time-consuming and require a great deal of manual labor, there is a need to automate the data conversion process. Moreover, before these processes can even begin, the database has to be appropriately configured to accept these data by creating database tables having columns appropriately named and typed. However, the data in existing applications may be manipulated by object-oriented (OO) classes, and manually studying these classes to determine the data types is laborious work. Also, these classes may include methods (procedures for manipulating the data) that do not easily translate onto off-the-shelf ERP components, requiring extensive programmer effort to modify, or more likely extend, the ERP code base.

### SUMMARY OF VARIOUS EMBODIMENTS

Illustrative embodiments eliminate much of the manual effort required to import data into an enterprise resource planning (ERP) system according to a three-phase process. In a design phase, a database engineer designs a series of import templates using an eXtensible Markup Language (XML) that defines mandatory or optional built-in operations that may be performed on the legacy software application's data using a Structured Query Language (SQL) during importation, such as validity checking and column renaming. In a configuration phase, a data import designer selects an import template on the basis of a business function associated with the data to be imported, selects which optional functions to perform, optionally provides a user-defined SQL function to perform during importation, and associates the import process with a project. Finally, in the execution phase, a data importer selects the configured template and imports the data.

Advantageously, the database engineer, data import designer, and data importer may be three different people having different skill sets. Also advantageously, once an import template has been designed with respect to a particular ERP system and a particular commercial legacy application, an integration specialist company may reuse the import template to perform integrations for multiple integration customers, thereby reducing the work of the database engineer and the data import designer, and making the integration process more efficient for the integration specialist.

Therefore, a first embodiment of the invention provides a method of automating the import of data, from a legacy business software application configured to use the data to implement a plurality of business functions, into an enterprise resource planning (ERP) system configured to use a database controlled according to a structured query language (SQL) to provide the plurality of business functions. The method includes retrieving, from a storage medium, an import template file that is written using an extensible markup language (XML), wherein the import template file is selected according to a business function associated with the data to be imported. The method also includes retrieving, from the import template file, a first plurality of XML tags, each tag in the first plurality of XML tags having SQL code implementing a mandatory or optional database process for importing data into the ERP system according to the business function. Next, the method requires customizing the import template according to the business function by receiving, from one or more web pages displayed using a second plurality of XML tags in the import template file, (a) a user selection of zero or more pre-defined optional database processes to perform, (b) a user input of zero or more user-defined database processes to perform, and (c) a mapping of legacy application data fields to ERP system database fields. Finally, the method requires importing the data from the legacy application according to the customized import template by (a) storing the data from the legacy application in the ERP system database according to the mapping, (b) performing the mandatory database processes on the stored data, (c) performing the selected optional database processes on the stored data, and (d) performing the user-defined database processes on the stored data.

Various modifications are contemplated. For example, the method may also include, for each tag in the first plurality of XML tags, compiling its SQL code and storing the compiled SQL code in the database prior to importing. Alternately, at least one of the mandatory or optional database processes is a data validation process that is specific to the business function associated with the data to be imported.

In a related embodiment, the method includes designing the import template file by defining a plurality of XML tags, each such XML tag having a meaning according to the business function associated with the data to be imported; storing the XML tags in the ERP system database; writing the import template file as an XML-SQL hybrid; and uploading the import template file to the ERP system database. In this embodiment, pre-processing the import template file may include converting the import template file to an XML DOM object having a plurality of XML tokens; and, for each XML token in the plurality: retrieving, from the ERP system database, SQL associated with the XML token; automatically adding, to the import template file, one or more XML tags in the second plurality of XML tags that indicate display elements, as a function of the meaning of the XML token; and compiling the retrieved SQL and associating it with the XML token. Moreover, it is contemplated that at least one XML token may have a meaning indicating that a mandatory or optional data validation process should be performed on the data to be imported, wherein the retrieved SQL is executable by the ERP system database to perform the mandatory or optional data validation process.

In another embodiment of the invention there is provided a non-transitory, tangible computer readable storage medium having thereon executable program code for automating the import of data, from a legacy business software application configured to use the data to implement a plurality of business functions, into an enterprise resource planning (ERP) system configured to use a database controlled according to a structured query language (SQL) to provide the plurality of business functions. In this embodiment, the program code includes program code for retrieving, from a storage medium, an import template file that is written using an extensible markup language (XML), wherein the import template file is selected according to a business function associated with the data to be imported. It also includes program code for retrieving, from the import template file, a first plurality of XML tags, each tag in the first plurality of XML tags having SQL code implementing a mandatory or optional database process for importing data into the ERP system according to the business function. It further includes program code for customizing the import template according to the business function by receiving, from one or more web pages displayed using a second plurality of XML tags in the import template file, (a) a user selection of zero or more pre-defined optional database processes to perform, (b) a user input of zero or more user-defined database processes to perform, and (c) a mapping of legacy application data fields to ERP system database fields. It finally includes program code for importing the data from the legacy application according to the customized import template by (a) storing the data from the legacy application in the ERP system database according to the mapping, (b) performing the mandatory database processes on the stored data, (c) performing the selected optional database processes on the stored data, and (d) performing the user-defined database processes on the stored data. The various modifications described above may be implemented using additional or varied program code.

In yet another embodiment of the invention there is provided an enterprise resource planning (ERP) system. The ERP system includes a database controlled according to a structured query language (SQL) to provide a plurality of business functions. The ERP system also includes a storage medium in which is stored an import template file that is written using an extensible markup language (XML), the import template file including a first plurality of XML tags, each tag in the first plurality of XML tags having SQL code implementing a mandatory or optional database process for importing data into the ERP system according to a selected business function in the plurality of business functions. The ERP system further includes a computer processor capable of executing program code. Finally, the ERP system includes a memory that includes program code for automating the import of data, from a legacy business software application configured to use the data to implement a plurality of business functions, into the ERP system. The program code is operable to customize the import template according to the selected business function by receiving, from one or more web pages displayed using a second plurality of XML tags in the import template file, (a) a user selection of zero or more pre-defined optional database processes to perform, (b) a user input of zero or more user-defined database processes to perform, and (c) a mapping of legacy application data fields to database fields. The program code also is operable to import the data from the legacy application according to the customized import template by (a) storing the data from the legacy application in the database according to the mapping, (b) performing the mandatory database processes on the stored data, (c) performing the selected optional database processes on the stored data, and (d) performing the user-defined database processes on the stored data. The various modifications described above may be implemented using additional or varied program code.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a software CEMLI management application that can be used to import data from legacy business software applications according to an embodiment of the invention.

FIG. 2 is a flowchart showing a method of importing data, from a legacy application into an enterprise resource planning (ERP) system that uses a database controlled according to a structured query language (SQL) to provide a plurality of business functions, according to an embodiment of the invention.

FIGS. 3A-3B are a flowchart showing a design phase for designing an import template for use in the method of FIG. 2.

FIGS. 4A-4B are a flowchart showing a configuration phase of the method of FIG. 2.

FIGS. 5A-5B are a flowchart showing an execution phase of the method of FIG. 2.

FIGS. 6-15 are screenshots of an exemplary embodiment of the configuration phase of FIGS. 4A-4B.

FIGS. 16-20 are screenshots of an exemplary embodiment of the execution phase of FIGS. 5A-5B.

### DESCRIPTION OF ILLUSTRATIVE EMBODIMENTS

Definitions. As used in this description and the accompanying claims, the following terms shall have the meanings indicated, unless the context otherwise requires:

A “business function” is a process or operation that is performed routinely to carry out a part of the mission of a business or organization.

“Enterprise Resource Planning” or “ERP” is software that may be used to collect, store, manage, and interpret data from a collection of business functions.

A “legacy business software application” or “legacy application” is a software application for performing business functions that is being replaced, in whole or in part, by corresponding ERP software.

“SQL” is the Structured Query Language for managing data held in a relational database management system, as standardized by the International Organization for Standardization (“ISO”) and the International Electrotechnical Commission (“IEC”) as ISO/IEC 9075, any of its predecessors or successors, and any related standards. For purposes of this disclosure, SQL expressly includes PL/SQL as developed by Oracle Corporation of Redwood City, Calif. Where the context is clear, SQL may also refer to code, written according to a SQL standard, for execution by a computer processor.

“XML” is any version of the Extensible Markup Language, including any of its parts, recommended by the World Wide Web Consortium (“W3C”) as a web standard for encoding hierarchical data using tags. When the context is clear, XML also means a particular set of hierarchy-defining constraints on the data encoding, as memorialized in a Document Type Definition (“DTD”), XML Schema Definition (“XSD”) recommended by the W3C as a web standard for this purpose, or a similar arrangement. In the context of particularly defined constraints, XML also may mean a document created according to those constraints.

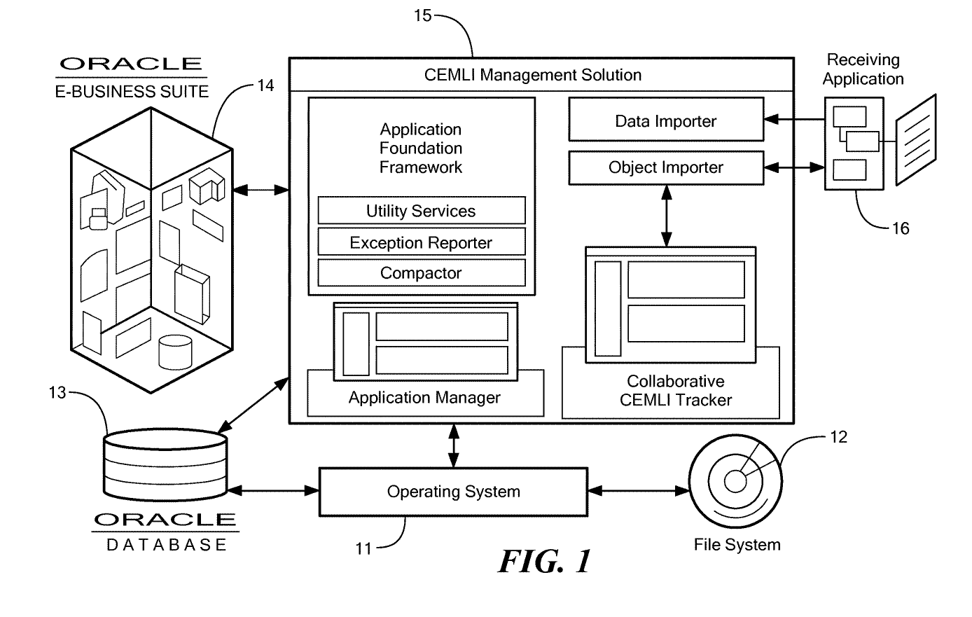

FIG. 1 schematically shows an Oracle ERP environment to which is attached a CEMLI software application that can be used to import data from legacy business software applications according to an embodiment of the invention. The ERP environment includes an operating system 11, such as Linux, or Microsoft Windows from Microsoft Corporation of Redmond, Washington. The operating system 11 communicates with a file system 12. The heart of the ERP environment is an Oracle database 13 that is executed using the operating system 11 and the file system 12. This database 13 is augmented with a collection of ERP applications 14, such as the Oracle E-Business Suite (EBS). To implement the Customization, Extension, Modification, Localization, and Integration (CEMLI) processes required to adapt the off-the-shelf ERP applications 14 to meet the need of a business, the embodiment of FIG. 1 includes a software CEMLI Management System (CMS) 15. The CMS 15 includes a data importer that receives program code and data from legacy applications and moves them to a staging area. The CMS 15 also includes an object importer that creates objects in support of a custom ERP application 16 that can run using the Oracle Application Framework. The CMS 15 includes an application manager that can be used to manage the various applications. The CMS 15 also has a collaborative CEMLI tracker that permits technicians to monitor and control the integration process. Finally, the CMS 15 has an application foundation framework that provides various services used by the various other components, such as utility services, an exception reporter, and a compactor.

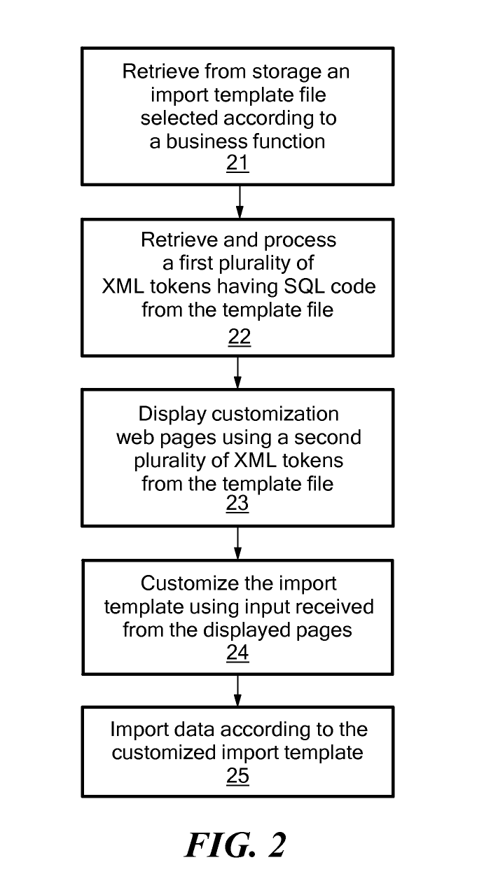

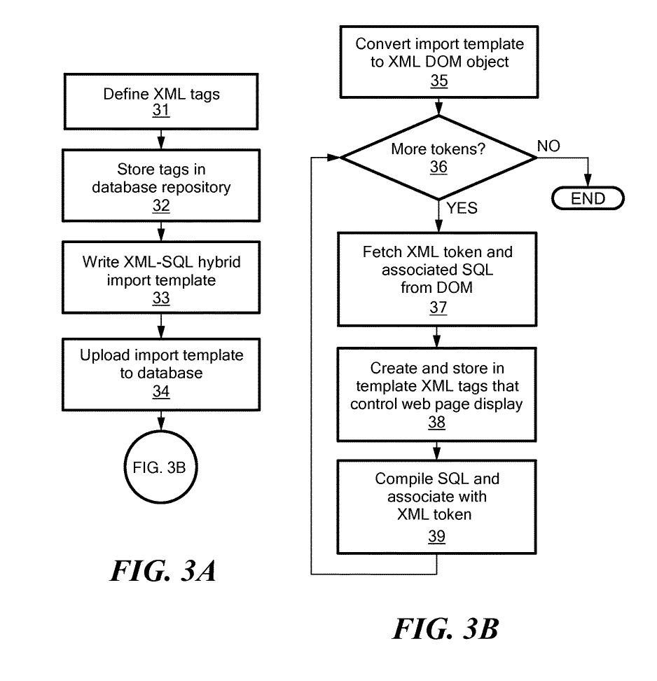

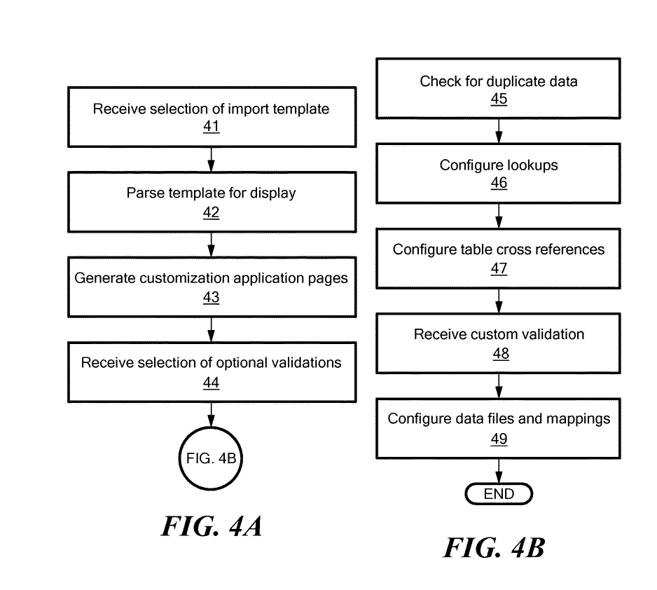

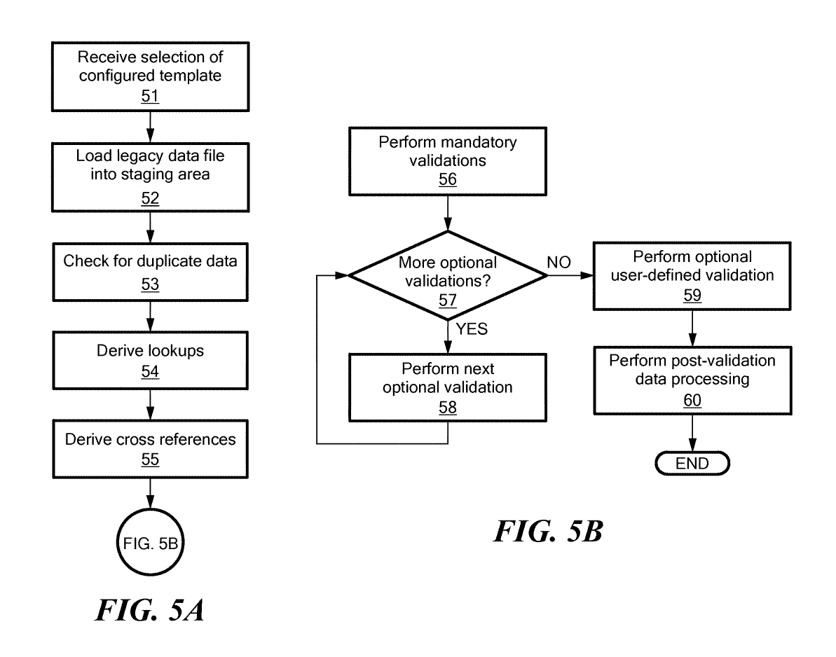

FIG. 2 is a flowchart showing a method of importing data, from a legacy application into an enterprise resource planning (ERP) system that uses a database controlled according to a structured query language (SQL) to provide a plurality of business functions, according to an embodiment of the invention. In process 21, the computer system retrieves from storage an import template file selected according to a business function. The creation and storage of this template file are performed in a design phase, described below in connection with FIGS. 3A-3B. In process 22, the computer system retrieves from the template file and processes a first plurality of XML tokens having SQL code. In process 23, the system displays customization web pages using a second plurality of XML tokens from the template file. In process 24, the system customizes the import template using input received from the displayed pages. The customization process is performed in a customization phase, described below in connection with FIGS. 4A-4B. Finally, in process 25, the system imports the data according to the customized import template. The importation process is performed in an execution phase, described below in connection with FIGS. 5A-5B.

FIGS. 3A-3B are a flowchart showing a design phase for designing an import template for use in the method of FIG. 2. Each template is processed to create a series of application pages for importing a template-specific type of data structure. For example, in a financial application, data pertaining to a chart of accounts may need to be migrated from the legacy application into the ERP system. Each different type of data structure many require a different template. The template itself is created and stored by a template developer using the processes of FIG. 3A, then the application computer system processes the template prior to performing an import using the processes of FIG. 3B.

In a first process 31, a developer starts by defining XML tags that will be used by an application for performing the conversion. These are free XML tags that are used in the application for various purposes. For example, if the template is used to import a chart of accounts, the user may define XML tags COA_M and COA_O to denote respectively mandatory and optional SQL procedures to execute when importing these data from the legacy application. In a second process 32, the tags are stored in a database repository for later access during a preprocessing phase shown in FIG. 3B.

In a third process 33, the developer writes an XML-SQL hybrid import template using the tags defined in process 31. A template is developed to complete any conversion as described above. each template contains all the logic required for completing a conversion. Thus, for each XML tag indicating a SQL procedure, the developer includes in the template an XML token, denoted by an opening tag (e.g. <tag>) and a closing tag (e.g. </tag>), whose body includes the appropriate SQL to be executed during import. Data used for performing the import, other than SQL procedures, may be stored in other XML tokens in the template. After the template is developed, it is uploaded in process 34. In one embodiment, this is done by using Oracle Application Framework screens developed for this purpose.

Referring now to FIG. 3B, the template created and stored by the processes 31-34 is now preprocessed. In a first process 35, the import template is converted into an XML DOM object. The Document Object Model (DOM) is an application programming interface (API) for HTML and XML documents. It defines the logical structure of documents, and the manner in which they are accessed and manipulated. In the DOM specification, the term “document” is used in the broad sense. XML is being increasingly used to represent many different kinds of information that may be stored in diverse systems. This information has been traditionally be seen as “data”; nevertheless, XML presents this data as documents. With DOM, anything found in an HTML or XML document can be accessed, changed, deleted, or added, with a few exceptions. In a preferred embodiment, the tokens are suffixed to the <HEAD> root tag, so their content is not rendered by a web browser.

Next, the template code is parsed for the XML tokens which were earlier defined, and the tokens are sequentially analyzed. In process 36, the ERP computer system determines whether the document includes more tokens. If not, then the method ends. Otherwise, in process 37 the computer system isolates the XML token from the DOM, and retrieves its associated SQL.

In process 38, the computer system adds to the template XML or HTML one or more tags indicating display elements, suffixed to the <BODY> tag, as a function of the designed meaning of the XML. One particularly common type of process is data validation, which may be mandatory, optional, or user-defined. For example, if a tag means that an SQL procedure is an optional validation, then the display element may include a textual description of the procedure and a checkbox that can be later checked by the user performing the actual data import if that validation is desired. However, if a tag means that an SQL procedure is a mandatory validation, then the display element may include a description of the procedure and a checkbox that is unchangeably checked (but is still displayed). Non-validation SQL procedures may includes establishing database packages, tables, and miscellaneous procedures or functions.

In process 39, the associated SQL procedure (if any) is compiled for optimal performance during data import or immediately executed, and the compiled SQL is associated with its XML tag in the application database for later access during import.

This ends the design phase. At this point in the process, a hybrid XML-SQL import template has been created for a legacy application object, various mandatory and optional data validation procedures have been defined, and associated SQL has been compiled and stored in the application database. The import application is now ready to be configured by a data import technician.

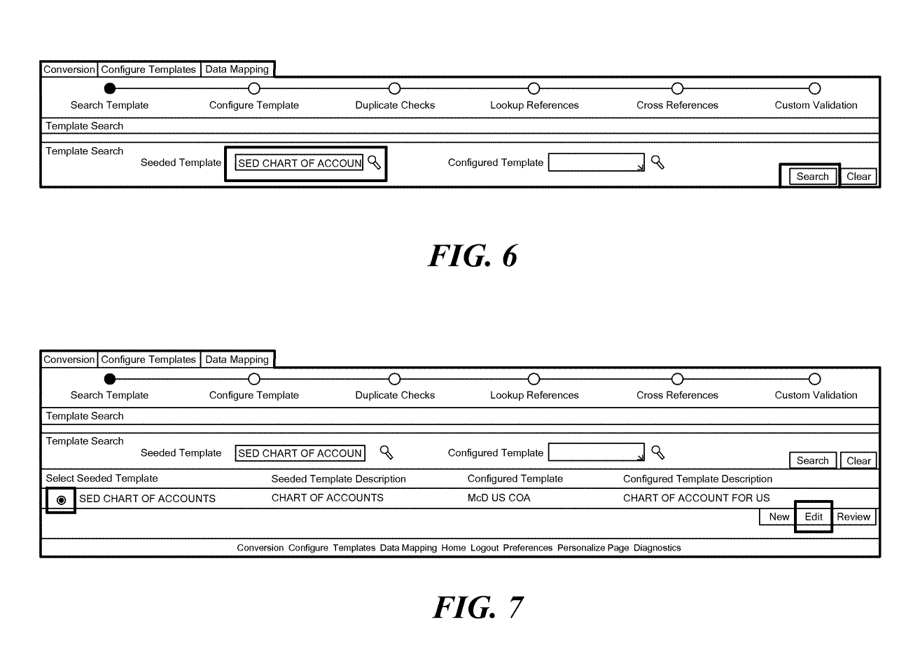

FIGS. 4A-4B are a flowchart showing a configuration phase of the method of FIG. 2. This phase starts after the design phase. In a first process 41, the computer system receives a selection of a hybrid XML-SQL import template according to a business function associated with the data to be imported. This is done by searching the template created in above process, as shown in FIG. 6. From the search results, an appropriate template is selected, as shown in FIG. 7. Once the template is selected, it is loaded in the application. The template itself was created and stored in the system according to the processes of FIGS. 3A-3B.

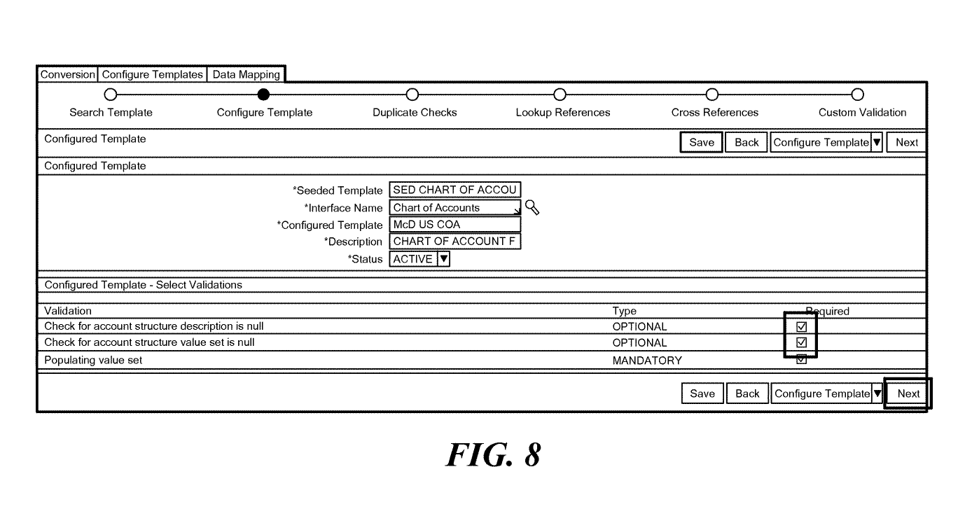

In process 42, the computer system parses the template to extract the display elements. These elements may include references to various tables in the application database. In process 43, the display elements and reference tables are used to generate customization application pages, which are then displayed to the importing user. One such web page is shown in FIG. 8. This generated page displays the function or procedure name followed by a description.

In process 44, the system receives a selection of optional validations to perform. Mandatory processes are always selected and cannot be overridden by the user. Optional processes are user selectable. Once user selects them, they will be executed during the eventual data import process. Unchecked processes will not be executed.

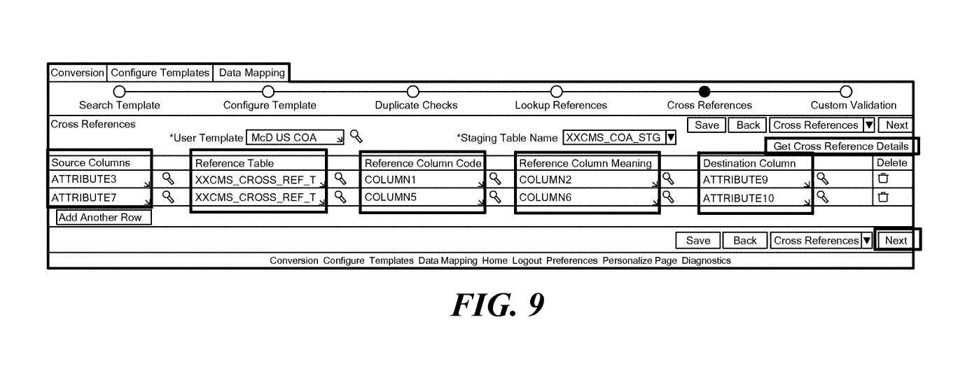

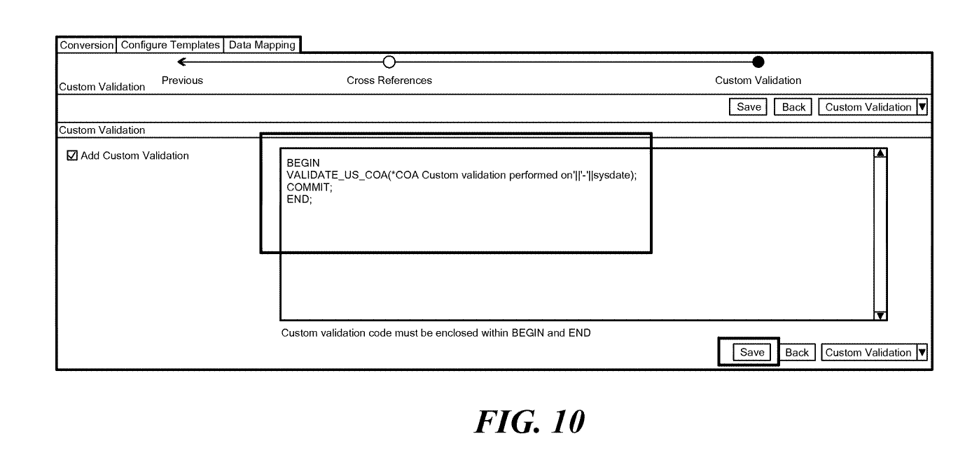

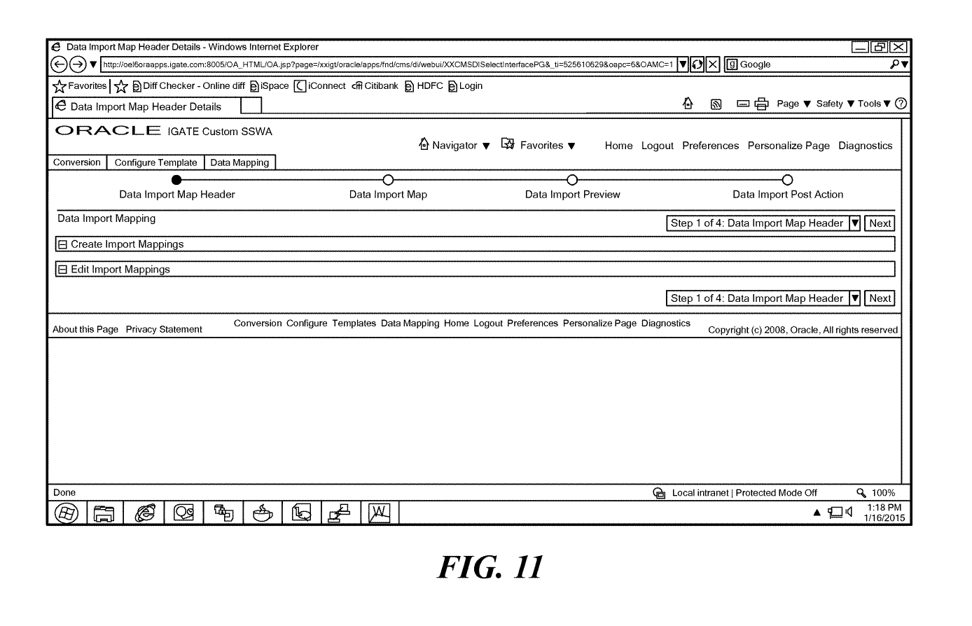

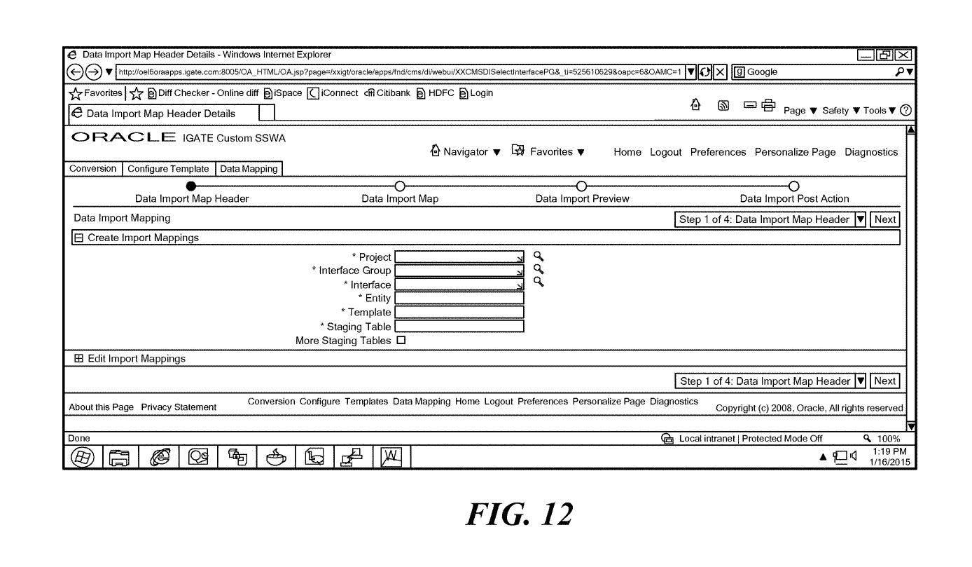

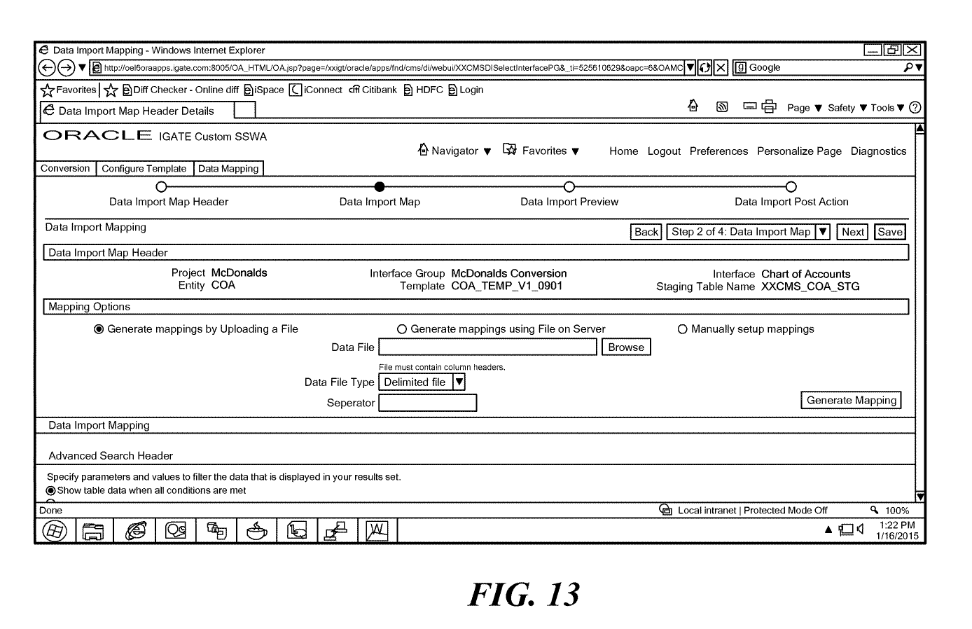

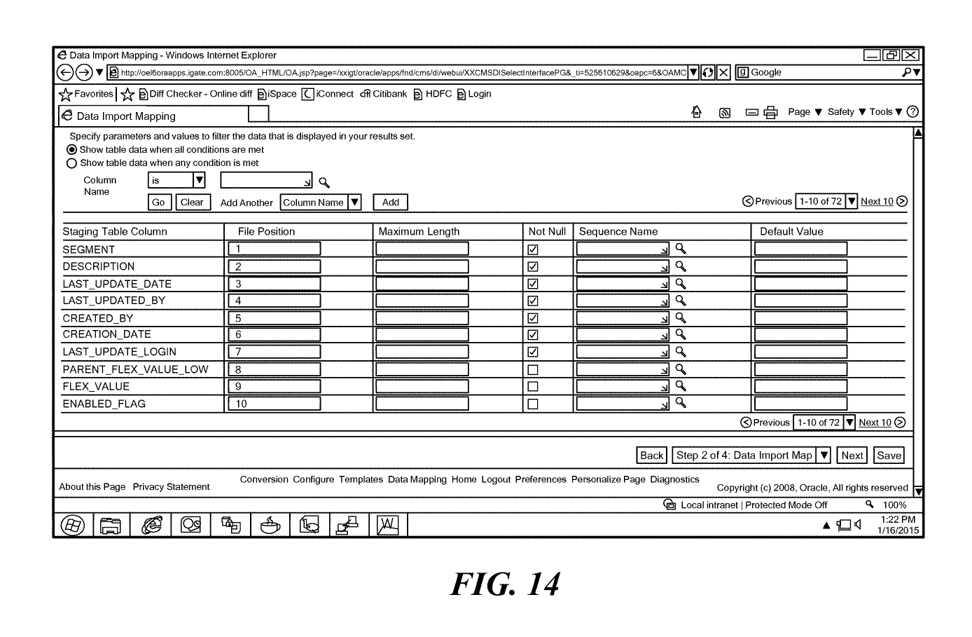

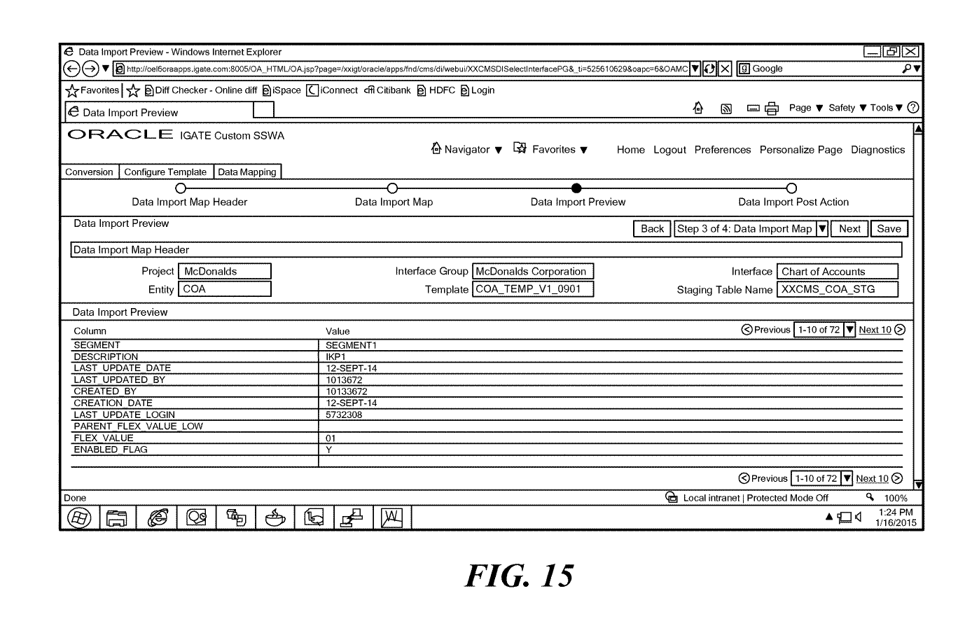

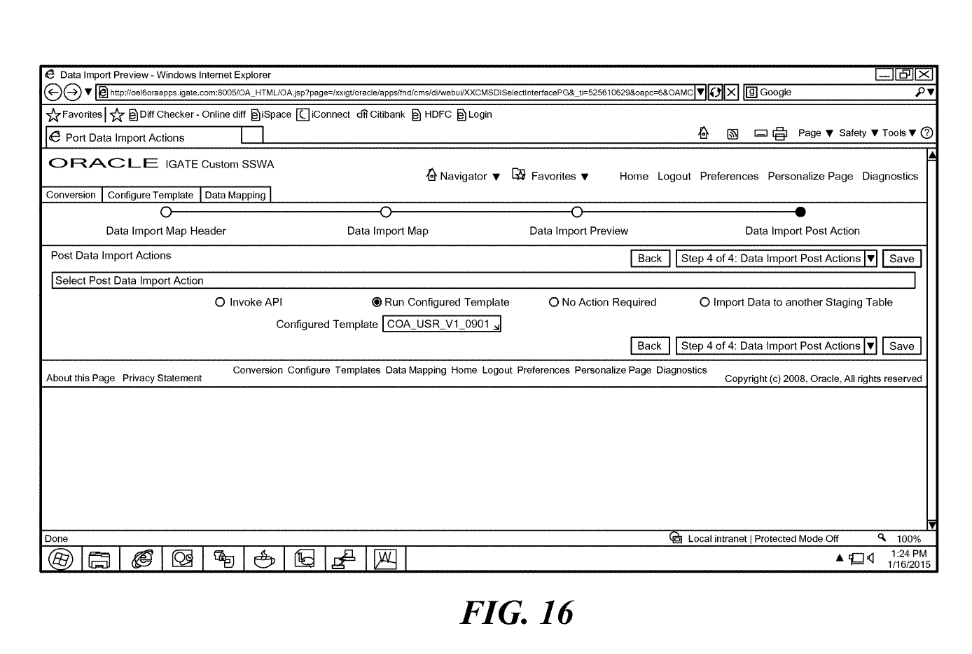

Once the validations are selected, the user proceeds to perform further configurations shown in FIG. 4B. Various configurations may include a check for duplicate data 45, configuration of lookups 46, and configuration of database table cross-references 47 as shown in FIG. 9. In process 48 the user optionally can add their own custom validation using SQL, as shown in FIG. 10. Finally, in process 49 the user configures a data importer application, which ties the pending data import to a project (as shown in FIGS. 11 and 12), identifies the data files to be imported, including their formats and delimiters (as shown in FIG. 13), defines a mapping of their legacy data format to an ERP database format (as shown in FIG. 14), shows a preview of an imported data record (as shown in FIG. 15), and the now-configured template is saved back into the database, ready to execute on live legacy data (as shown in FIG. 16).

It should be appreciated that the processes of FIGS. 3A-3B create and store an import template that may be used to import a particular type of data structure across different enterprises, while the processes of FIGS. 4A-4B configure such a template for use with a particular enterprise. Thus, these templates advantageously may be used by an ERP service organization to perform data importation for a large number of enterprise customers, without revision to the templates themselves, through the customization process. Once a robust set of templates has been created, the service organization may service a wide variety of customers without expending what would otherwise be significant resources to develop data importation software for each customer.

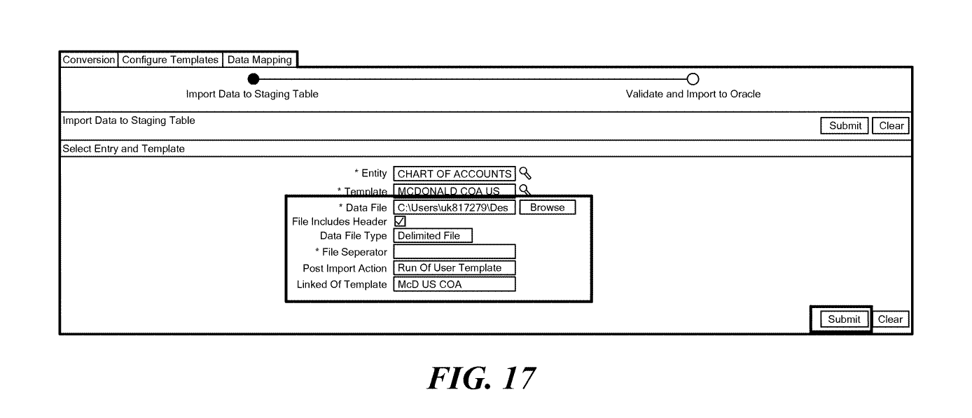

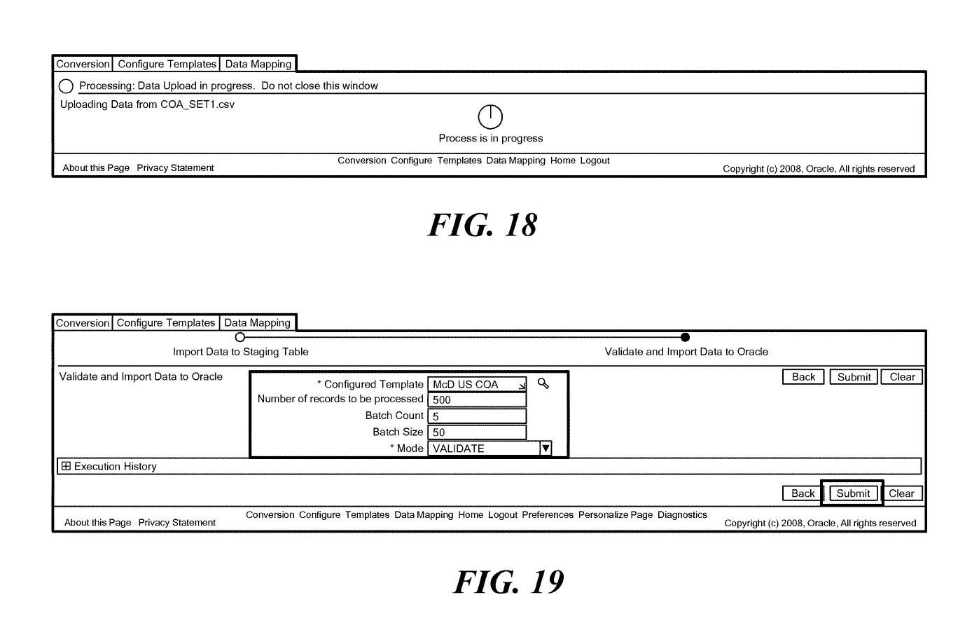

FIGS. 5A-5B are a flowchart showing an execution phase of the method of FIG. 2. In particular, FIG. 5A shows the data importing process prior to validation, while FIG. 5B shows validation processes. Data importing starts in process 51 with receiving a selection of a previously configured template created in the above process. As a first step, a user configured template is selected and the legacy data file pertaining to the conversion object is selected by the browse window, as shown in FIG. 17. Once this is done, and a submit button is pressed, process 52 loads the legacy data file into a database staging table. For example, in one embodiment this is carried out by components developed using Java and Oracle Application Framework code. During this time, an “in process” screen is shown as in FIG. 18.

Once the data are uploaded, various pre-validation steps are performed. To this end, a user configured template that defines the processes is selected, and various parameters configured, as shown in FIG. 19. In particular, a duplicate check is performed in process 53. Procedures for detecting duplicate or non-normalized data are accessed and executed in this process. After this, in process 54 lookups are validated and derived using template SQL procedures for this purpose. Then, in process 55 cross-references are derived using template SQL procedures for this purpose.

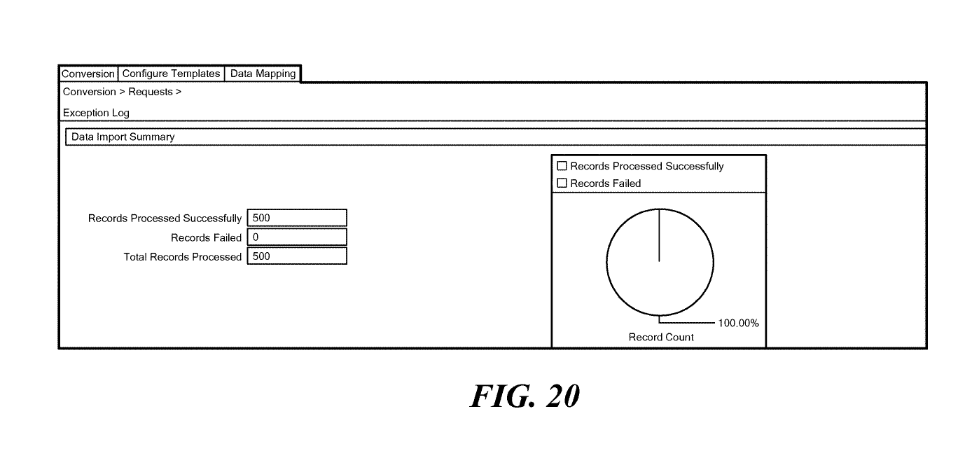

Once these steps are completed, data validation proper can begin. With reference to FIG. 5B, in process 56 all mandatory validations are performed that are required for data conversion. Mandatory validations may be required to format the data according to various ERP standards. Next, optional validations are performed in a loop. Thus, in process 57, the computer system determines whether there are any additional optional validations to be performed. If so, in process 58 the next validation is performed using SQL from the template, and the system returns to process 57. Once all optional validation procedures have been invoked, the optional user-defined, custom validation procedure is executed in process 59. Finally, in process 60, after custom validations are performed the template executes any SQL code required for completing the data conversion process. Upon completion, a summary screen may be shown as in FIG. 20.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention.

What is claimed is:

1. A method of automating the import of data, from a legacy business software application configured to use the data to implement a plurality of business functions, into an enterprise resource planning (ERP) system configured to use a database controlled according to a structured query language (SQL) to provide the plurality of business functions, the method comprising:
retrieving, from a storage medium, an import template file that is written using an extensible markup language (XML), wherein the import template file is selected according to a business function associated with the data to be imported;
retrieving, from the import template file, a first plurality of XML tags, each tag in the first plurality of XML tags having SQL code implementing a mandatory or optional database process for importing data into the ERP system according to the business function;
customizing the import template according to the business function by receiving, from one or more web pages displayed using a second plurality of XML tags in the import template file, (a) a user selection of zero or more pre-defined optional database processes to perform, (b) a user input of zero or more user-defined database processes to perform, and (c) a mapping of legacy application data fields to ERP system database fields; and
importing the data from the legacy application according to the customized import template by (a) storing the data from the legacy application in the ERP system database according to the mapping, (b) performing the mandatory database processes on the stored data, (c) performing the selected optional database processes on the stored data, and (d) performing the user-defined database processes on the stored data.

2. The method according to claim 1, further comprising, for each tag in the first plurality of XML tags, compiling its SQL code and storing the compiled SQL code in the database prior to importing.

3. The method according to claim 1, wherein at least one of the mandatory or optional database processes is a data validation process that is specific to the business function associated with the data to be imported.

4. The method according to claim 1, further comprising designing the import template file by:
defining a plurality of XML tags, each such XML tag having a meaning according to the business function associated with the data to be imported;
storing the XML tags in the ERP system database;
writing the import template file as an XML-SQL hybrid; and
uploading the import template file to the ERP system database.

5. The method according to claim 4, further comprising pre-processing the import template file by:
converting the import template file to an XML DOM object having a plurality of XML tokens; and
for each XML token in the plurality:
retrieving, from the ERP system database, SQL associated with the XML token;
automatically adding, to the import template file, one or more XML tags in the second plurality of XML tags that indicate display elements, as a function of the meaning of the XML token; and
compiling the retrieved SQL and associating it with the XML token.

6. The method according to claim 5, wherein at least one XML token has a meaning indicating that a mandatory or optional data validation process should be performed on the data to be imported, and wherein the retrieved SQL is executable by the ERP system database to perform the mandatory or optional data validation process.

7. A non-transitory, tangible computer readable storage medium having thereon executable program code for automating the import of data, from a legacy business software application configured to use the data to implement a plurality of business functions, into an enterprise resource planning (ERP) system configured to use a database controlled according to a structured query language (SQL) to provide the plurality of business functions, the program code comprising:
program code for retrieving, from a storage medium, an import template file that is written using an extensible markup language (XML), wherein the import template file is selected according to a business function associated with the data to be imported;
program code for retrieving, from the import template file, a first plurality of XML tags, each tag in the first plurality of XML tags having SQL code implementing a mandatory or optional database process for importing data into the ERP system according to the business function;
program code for customizing the import template according to the business function by receiving, from one or more web pages displayed using a second plurality of XML tags in the import template file, (a) a user selection of zero or more pre-defined optional database processes to perform, (b) a user input of zero or more user-defined database processes to perform, and (c) a mapping of legacy application data fields to ERP system database fields; and
program code for importing the data from the legacy application according to the customized import template by (a) storing the data from the legacy application in the ERP system database according to the mapping, (b) performing the mandatory database processes on the stored data, (c) performing the selected optional database processes on the stored data, and (d) performing the user-defined database processes on the stored data.

8. The storage medium according to claim 7, further comprising program code for, for each tag in the first plurality of XML tags, compiling its SQL code and storing the compiled SQL code in the database prior to importing.

9. The storage medium according to claim 7, wherein at least one of the mandatory or optional database processes is a data validation process that is specific to the business function associated with the data to be imported.

10. The storage medium according to claim 7, further comprising program code for designing the import template file by:
defining a plurality of XML tags, each such XML tag having a meaning according to the business function associated with the data to be imported;
storing the XML tags in the ERP system database;
writing the import template file as an XML-SQL hybrid; and
uploading the import template file to the ERP system database.

11. The storage medium according to claim 10, further comprising program code for pre-processing the import template file by:
converting the import template file to an XML DOM object having a plurality of XML tokens; and
for each XML token in the plurality:
retrieving, from the ERP system database, SQL associated with the XML token;
automatically adding, to the import template file, one or more XML tags in the second plurality of XML tags that indicate display elements, as a function of the meaning of the XML token; and
compiling the retrieved SQL and associating it with the XML token.

12. The storage medium according to claim 11, wherein at least one XML token has a meaning indicating that a mandatory or optional data validation process should be performed on the data to be imported, and wherein the retrieved SQL is executable by the ERP system database to perform the mandatory or optional data validation process.

13. An enterprise resource planning (ERP) system comprising:
a database controlled according to a structured query language (SQL) to provide a plurality of business functions;
a storage medium in which is stored an import template file that is written using an extensible markup language (XML), the import template file including a first plurality of XML tags, each tag in the first plurality of XML tags having SQL code implementing a mandatory or optional database process for importing data into the ERP system according to a selected business function in the plurality of business functions;
a computer processor capable of executing program code; and
a memory that includes program code for automating the import of data, from a legacy business software application configured to use the data to implement a plurality of business functions, into the ERP system, the program code being operable to:
customize the import template according to the selected business function by receiving, from one or more web pages displayed using a second plurality of XML tags in the import template file, (a) a user selection of zero or more pre-defined optional database processes to perform, (b) a user input of zero or more user-defined database processes to perform, and (c) a mapping of legacy application data fields to database fields; and
import the data from the legacy application according to the customized import template by (a) storing the data from the legacy application in the database according to the mapping, (b) performing the mandatory database processes on the stored data, (c) performing the selected optional database processes on the stored data, and (d) performing the user-defined database processes on the stored data.

14. The ERP system according to claim 13, wherein the program code is further operable for, for each tag in the first plurality of XML tags, compiling its SQL code and storing the compiled SQL code in the database prior to importing.

15. The ERP system according to claim 13, wherein at least one of the mandatory or optional database processes is a data validation process that is specific to the business function associated with the data to be imported.

16. The ERP system according to claim 13, wherein the program code is further operable for designing the import template file by:
defining a plurality of XML tags, each such XML tag having a meaning according to the business function associated with the data to be imported;
storing the XML tags in the database;
writing the import template file as an XML-SQL hybrid; and
uploading the import template file to the database.

17. The ERP system according to claim 16, wherein the program code is further operable for pre-processing the import template file by:
converting the import template file to an XML DOM object having a plurality of XML tokens; and
for each XML token in the plurality:
retrieving, from the database, SQL associated with the XML token;
automatically adding, to the import template file, one or more XML tags in the second plurality of XML tags that indicate display elements, as a function of the meaning of the XML token; and
compiling the retrieved SQL and associating it with the XML token.

18. The ERP system according to claim 17, wherein at least one XML token has a meaning indicating that a mandatory or optional data validation process should be performed on the data to be imported, and wherein the retrieved SQL is executable by the database to perform the mandatory or optional data validation process.
